(19) United States
(12) Patent Application Publication
(10) Pub. No.: US 2014/0348130 A1
(43) Pub. Date: Nov. 27, 2014

(54) System and Method for Distributed Evolved Packet Core Architecture

(71) Applicant: Futurewei Technologies, Inc., Plano, TX (US)

(72) Inventors: John Kaippallimalil, Richardson, TX (US); Hinghung Anthony Chan, Plano, TX (US); Zhixian Xiang, Plano, TX (US); Khosrow Tony Saboorian, Plano, TX (US); Serge Manning, Plano, TX (US)

(21) Appl. No.: 14/284,107

(22) Filed: May 21, 2014

Related U.S. Application Data
(60) Provisional application No. 61/826,362, filed on May 22, 2013.

(51) Int. Cl. H04W 36/00; H04W 76/02

(52) U.S. Cl. CPC H04W 36/0016; H04W 76/022
USPC 370/331

(57) ABSTRACT

An embodiment method for session handling for a connection between an UE and a network includes establishing, at a first distributed EPC, user and IP sessions over the connection through the first distributed EPC. The first distributed EPC includes a first PGW at which the IP session is anchored. The method also includes holding original IP resources and releasing original connection resources for the sessions at the first distributed EPC when the UE moves beyond the first distributed EPC to a second distributed EPC. The method then establishes a tunnel between the first PGW and a second PGW for the second distributed EPC. The tunnel utilizes the original IP resources and new connection resources at the second distributed EPC. The method then routes data from the tunnel, through the first PGW, and to the network.

This application claims the benefit of U.S. Provisional Application No. 61/826,362 titled “System and Method for Distributed Evolved Packet Core Architecture,” filed on May 22, 2013 by Kaippallimalil et al., which application is hereby incorporated herein by reference.

### TECHNICAL FIELD

The present invention relates generally to an evolved packet core (EPC) architecture and, in particular embodiments, to a system and method for a distributed EPC.

### BACKGROUND

3GPP LTE and Wi-Fi use centralized architectures where user sessions are managed in highly centralized data centers or central offices. Due to the proliferation of highly functional user equipment (UE) that allow users to multi-task, for example, surf the internet, instant message and stream videos at the same time, the handling of user sessions in the data centers or central office can approach the performance limits of the data centers or central office.

In addition, with the increased deployment of small cells, het-net, machine to machine (M2M), and networks of devices, where thousands or millions of devices are attached, there are a large number of user sessions, some of which are more local (i.e., originate and terminate in nearby locations), while others are more distant. Each of these devices may be mobile. An evolved packet core (EPC) network anchors the Internet protocol (IP) session centrally and thus is able to maintain the same IP session while a device transitions between layer 2 anchor points.

### SUMMARY OF THE INVENTION

In accordance with a preferred embodiment of the present invention, a method of managing a user session and an internet protocol (IP) session for a connection between an user equipment (UE) and a network includes establishing, at a first distributed evolved packet core (EPC), the user session and the IP session over the connection through the first distributed EPC. The first distributed EPC includes a first packet data network (PDN) gateway (PGW) at which the IP session is anchored. The method also includes holding original IP resources for the IP session and releasing original connection resources for the user session at the first distributed EPC when the UE moves beyond the first distributed EPC to a second distributed EPC. The method then establishes a tunnel between the first PGW and a second PGW for the second distributed EPC. The tunnel utilizes the original IP resources and new connection resources at the second distributed EPC. The method then routes data for the user session and the IP session from the tunnel, through the first PGW, and to the network.

An embodiment distributed EPC includes a user plane and a control plane. The user plane is couplable between a network and a radio node serving a UE. The user plane includes a PGW and a SGW. The PGW is configured to anchor an IP session for the UE. The SGW is configured to anchor a user session for the UE. The control plane includes a mobility management entity (MME) configured to coordinate a first connection for the IP session and the user session. When the UE transitions to being served by another radio node coupled to another distributed EPC, the MME is configured to instruct the PGW to release connection resources and hold IP resources for the first connection. The MME is further configured to inform a centralized EPC of the release and the hold. The MME is further configured to coordinate a second connection for the IP session and the user session through a tunnel between the PGW and another PGW for the another distributed EPC according to an authorization from the centralized EPC.

An embodiment EPC for serving a UE includes a central EPC, a first distributed EPC, and a second distributed EPC. The central EPC includes a home subscriber server (HSS) configured to store authentication information and to authenticate and identify the UE. The first distributed EPC includes a first SGW, a first PGW, and a first MME. The first SGW is couplable to a first radio node. The first SGW is configured to anchor a user session for the UE and to route user data to and from the UE through the first radio node. The first PGW is couplable between the first SGW and a network. The first PGW is configured to anchor an IP session for the UE and to route the user data between the first SGW and the network. The first MME is configured to receive an authentication of the UE from the HSS and coordinate establishment of the user session and the IP session. The second distributed EPC includes a second SGW, a second PGW, and a second MME. The second SGW is couplable to a second radio node and is configured to route the user data to and from the second radio node. The second PGW is couplable between the second SGW and the network. The second PGW is configured to route the user data between the second SGW and the network. When the UE transitions from being served by the first radio node to being served by the second radio node, the first MME is configured to instruct the first PGW to release connection resources for the user session and to hold IP resources for the IP session. The first MME then informs the HSS of the release of the connection resources and of the hold of the IP resources. When the UE initiates connectivity with the second radio node, the second MME is configured to receive a re-authentication of the UE from the HSS. The second MME then coordinates with the HSS and the first MME to establish a tunnel between the first PGW and the second PGW. The tunnel is established according to the IP resources. The user data is then routed from the UE to the second PGW, through the tunnel to the first PGW, and to the network.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram of one embodiment of a communication system;

FIG. 2 is a block diagram of one embodiment of an EPC;

FIG. 3 is a block diagram illustrating a UE transitioning from being served by one distributed EPC to being served by another distributed EPC;

FIG. 4 is a flow diagram of one embodiment of a method of managing a user session and an IP session for a connection between a UE and a network; and

FIG. 5 is a block diagram of a processing system.

### DETAILED DESCRIPTION OF ILLUSTRATIVE EMBODIMENTS

The making and using of embodiments are discussed in detail below. It should be appreciated, however, that the present invention provides many applicable inventive concepts that may be embodied in a wide variety of specific contexts. The specific embodiments discussed are merely illustrative of specific ways to make and use the invention, and do not limit the scope of the invention.

The EPC is a network architecture that provides a functional framework for handling user data and user sessions for multiple users, i.e., UEs. The EPC connects an access network, such as an LTE access network, to one or more external networks. External networks can include the Internet, corporate networks, and the IP multimedia core network subsystem (IMS). The access network typically includes multiple radio nodes to which the various UEs connect to access the external networks or to communicate with other UEs on the access network.

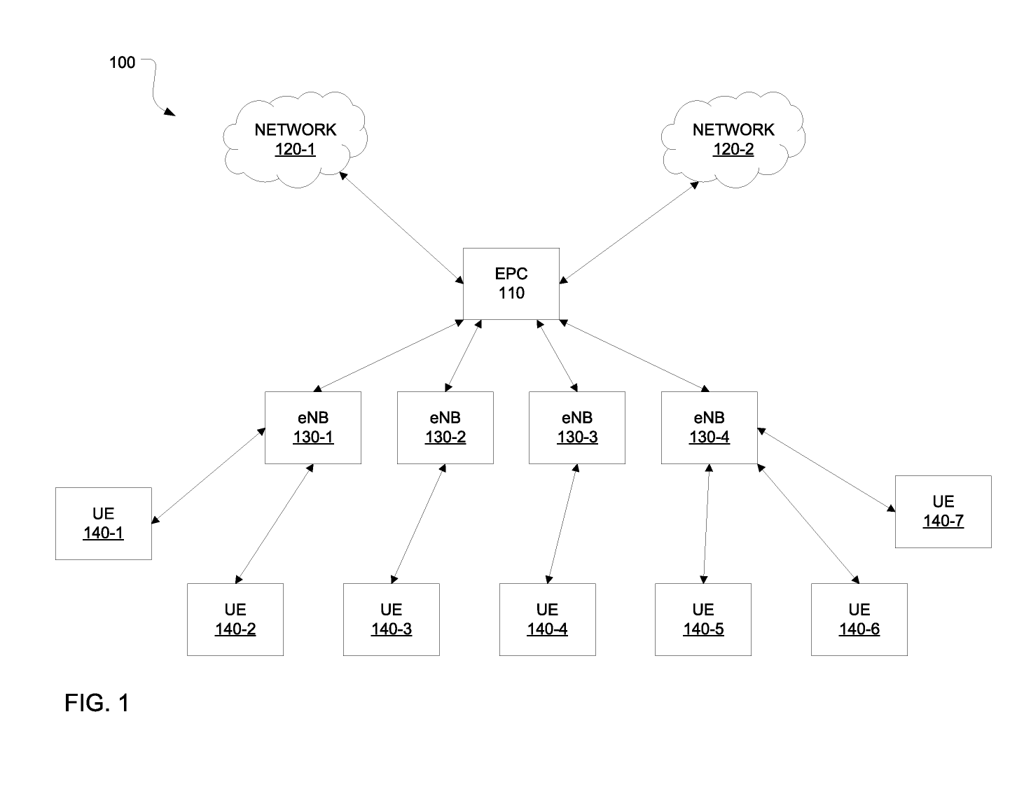

FIG. 1 is a block diagram of one embodiment of a communication system 100. Communication system 100 includes an EPC 110 that connects an access network to external networks 120-1 and 120-2. The access network includes multiple radio nodes. In certain embodiments, a radio node is an enhanced node B (eNB). Communication system 100 includes eNBs 130-1 through 130-4. eNBs 130-1 through 130-4 provide radio access to mobile users, i.e., UEs 140-1 through 140-7. eNBs 130-1 through 130-4 provide access to external networks 120-1 and 120-2.

In alternative embodiments, communication system 100 can include any number of radio nodes and UEs. In other embodiments, EPC 110 can connect the access network to any number of external networks. In certain embodiments, multiple EPCs can connect to each other through external networks 120-1 and 120-2.

A typical EPC includes several functional modules, the functions of which are generally categorized as in a user plane or in a control plane. The user plane handles user data, i.e., payload data. The control plane coordinates connections and administers policies. Basic elements of the user plane include serving gateways (SGWs) and a packet data network (PDN) gateway (PGW). Basic elements of the control plane include a home subscriber server (HSS), a mobility management entity (MME), a policy and charging rules function (PCRF), and a subscriber provisioning repository (SPR). For further information regarding the EPC network architecture, see 3GPP Technical Specification 23.002, Mar. 10, 2014, which is hereby incorporated herein by reference.

The HSS is a database that contains user-related and subscriber-related information. The HSS also provides support functions in mobility management, call and session setup, user authentication, and access authorization. The MME handles signaling and logic related to selecting appropriate eNBs, SGWs, and PGWs, coordinating and setting up connections, and managing resources for various sessions. The MME also supports authentication and identification, among many other functions. The PCRF is a policy decision point for policy and charging control of service data flows. The PCRF also selects and provides applicable policy and charging decisions. In some cases, the PCRF provides dynamic quality of service (QoS) control policies. The SPR stores subscriber related information needed for subscription-based policies and charging control by the PCRF.

SGWs transport IP data traffic between UEs and external networks. The SGWs serve as the interface between radio nodes and the EPC and also serve as an anchor point for UE sessions and for layer 2 mobility among radio nodes. The SGWs are logically connected to the PGW. The PGW anchors IP sessions for the UEs and serves as an interface between external networks and the EPC. The PGW transports IP data traffic to and from the external networks, which are sometimes referred to as PDNs.

During a UE's transition from being served by a radio node coupled to one PGW to being served by another radio node coupled to another PGW, in a typical EPC, a first MME for the one PGW informs a second MME for the other PGW about context transfer during handover. The communication is initiated upon a request by the UE to the first MME to release its resources. It is realized herein that the UE can inform the second MME of the context transfer directly, and the second MME can inform the first MME.

A typical system hosts the SGW, PGW and servers such as MME, PCRF, etc., in a centralized data center or central office. Various networks, such as broadband, cable or dedicated fiber networks, backhaul IP traffic between the eNBs and the SGW. All the IP sessions for the corresponding user sessions are backhauled to the PGW in the central data center. From there the IP sessions are routed to respective destinations. When the UE sessions in a particular region served by the EPC increase, or reach a certain density, it is realized herein, the backhauled IP sessions will approach the capacity of the PGW.

It is realized herein that user sessions and IP sessions can be more efficiently handled by distributing certain EPC functionality while retaining centralization of other EPC functionality. Session handling functions, including those carried out by the MME, SGW, and PGW, can be distributed more locally with respect to access networks and their respective radio nodes. Distributed functionality can be implemented on dedicated servers or can be implemented virtually at the various distributed locations. It is realized herein that certain subscription related functionality, including those carried out by the HSS and SPR, can remain centralized, while others, including that carried out by the PCRF, can be distributed. The centralized components for policy and network selection can manage static, overall policy for the domain. The distributed components can manage policy and network selection at a user level, per IP data flow. It is also realized herein that policy and network selection can be partially or fully distributed. When partially distributed, a centralized policy and network selection function coordinates overall policy with subscriber information and dynamic network status. Otherwise, in fully distributed architectures, these functions are distributed to the various distributed to the various distributed EPCs. It is further realized herein that in a distributed EPC, IP data flows are not necessarily backhauled to a central data center; rather they are routed to the destination external network from the distributed EPC.

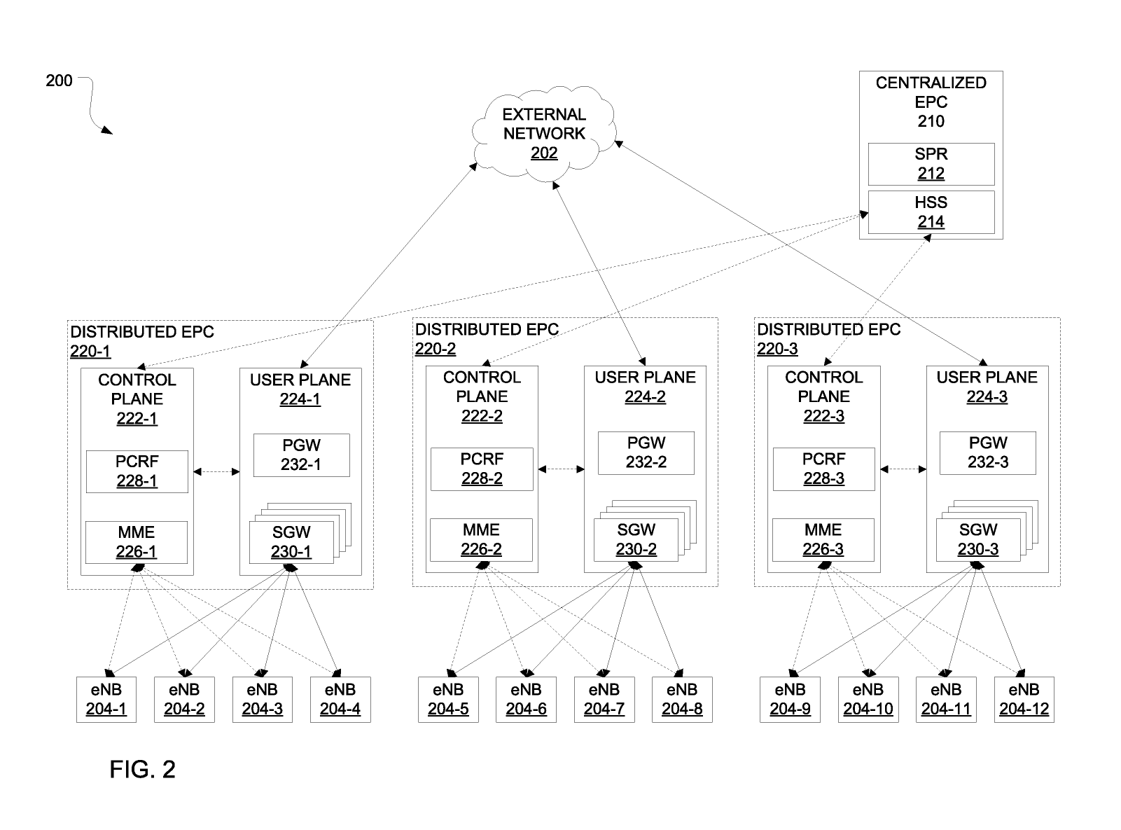

FIG. 2 is a block diagram of one embodiment of an EPC 200. EPC 200 includes a centralized EPC 210 and distributed EPCs 220-1, 220-2, and 220-3. Centralized EPC 210 includes an HSS 214 and a SPR 212. Distributed EPCs 220-1, 220-2, and 220-3 connect eNBs 204-1 through 204-12 to an external network 202.

Each of distributed EPCs 220-1, 220-2, and 220-3 include respective control planes and user planes. For example, distributed EPC 220-1 includes a control plane 222-1 and a user plane 224-1. User plane 224-1 handles user data flowing from eNBs 204-1 through 204-4 to external network 202. User plane 224-1 includes a plurality of SGWs 230-1 that serve as an interface between EPC 200 and eNBs 204-1 through 204-4. SGWs 230-1 anchor user sessions for UEs being served by eNBs 204-1 through 204-4. SGWs 230-1 are logically connected to a PGW 232-1. PGW 232-1 serves as an interface between EPC 200 and external network 202. PGW 232-1 anchors IP sessions for UEs being served by eNBs 204-1 through 204-4. Control plane 222-1 includes PCRF 228-1 and MME 226-1. PCRF 228-1 serves as a policy decision point for PGW 232-1. MME 226-1 coordinates connections for UEs through eNBs 204-1 through 204-4, SGWs 230-1, and PGW 232-1. Certain control signals flow from control plane 220-1 up to centralized EPC 210.

PCRFs 228-1 through 228-3, MMEs 226-1 through 226-3, PGWs 232-1 through 232-3, and SGWs 230-1 through 230-3 can be implemented in one or more processors, one or more application specific integrated circuits (ASICs), one or more field-programmable gate arrays (FPGAs), dedicated logic circuitry, or any combination thereof, all collectively referred to as a processor. The respective functions for PCRFs 228-1 through 228-3 and MMEs 226-1 through 226-3 can be stored as instructions in non-transitory memory for execution by the processor.

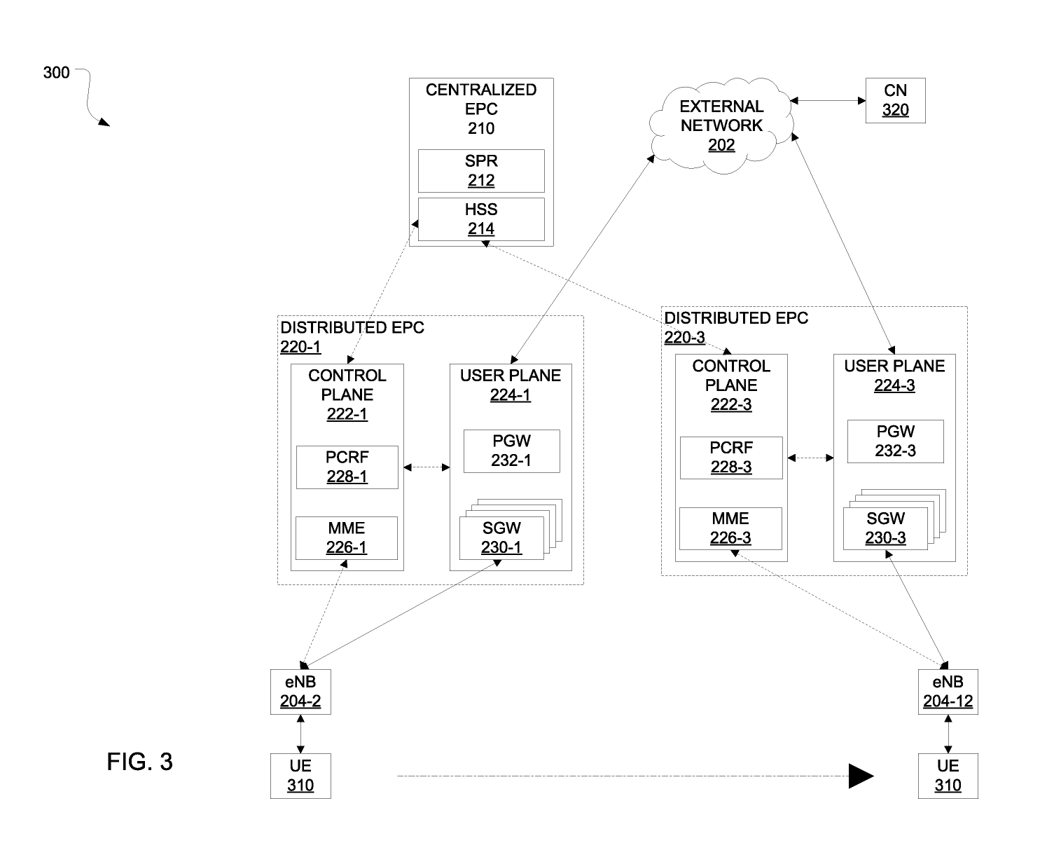

FIG. 3 is a block diagram of an EPC 300 illustrating how a UE 310 transitions from being served by an eNB 204-2 to being served by an eNB 204-12. EPC 300 includes centralized EPC 210 and distributed EPCs 220-1 and 220-3 that connect external network 202 to UEs being served by eNBs 204-1 through 204-12, all from the embodiment of FIG. 2. EPC 300 serves UE 310 by connecting it to a corresponding node (CN) 320 through external network 202.

Initially, UE 310 is served by distributed EPC 220-1 through eNB 204-2. UE 310 is authenticated by HSS 214 via control signaling from MME 226-1. Once authenticated, an IP data flow is established from UE 310, through eNB 204-2, SGW 230-1, PGW 232-1, and on through external network 202 to CN 320. A user session for UE 310 is anchored at SGW 230-1. An IP session is anchored at PGW 232-1.

When UE 310 changes location, it transitions from being served by eNB 204-2 to being served by eNB 204-12. UE 310 signals eNB 204-12, and ultimately MME 226-3 to request release of connectivity resources. MME 226-3 informs MME 226-1 of the request, and MME 226-1 instructs PGW 232-1 to release the connectivity resources and signals HSS 214 to notify it of the released connectivity resources. MME 226-1 also informs HSS 214 that IP resources for UE 310 are being held, which generally includes an IP address for UE 310. HSS 214 is configured to maintain multiple session bindings for UE 310.

UE 310 then initializes a connection with eNB 204-12 at its new location. eNB 204-12 relays the control signal to MME 226-3 to setup the connection with the held IP resources. MME 226-3 re-authenticates UE 310 with HSS 214. HSS 214 provides the held IP resources, including the address of PGW 232-1. MME 226-3 coordinates the connection with PGW 232-3 through SGW 230-3 and eNB 204-12. MME 226-3 also coordinates with PGW 232-3 to establish a tunnel from PGW 232-3 and PGW 232-1. The IP session remains anchored at PGW 232-1, while the user session transitions to SGW 230-3. User data from UE 310 is then routed from eNB 204-12, to SGW 230-3, to PGW 232-3, through the tunnel to PGW 232-1, and on to external network 202 and CN 320.

UE 310 can also establish new IP sessions directly through SGW 230-3 and PGW 232-3 to external network 202, all while maintaining the IP data flow through the tunnel to PGW 232-1 for the original IP session.

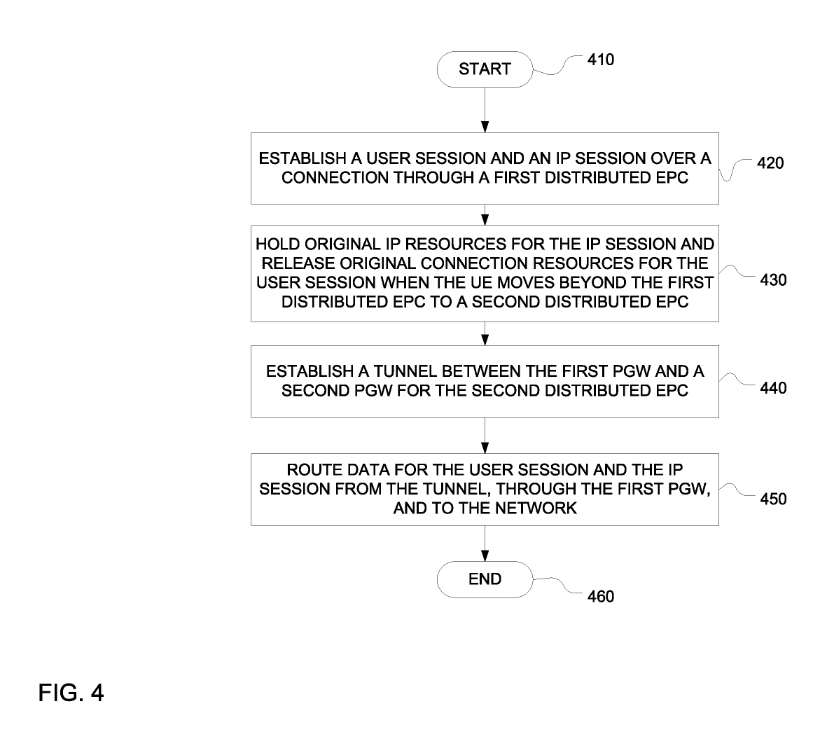

FIG. 4 is a flow diagram for one embodiment of a method of managing a user session and an IP session for a connection between a UE and a network. The method begins at a start step 410. At a first connecting step 420, a user session and an IP session are established at a first distributed EPC. The IP session is anchored at a first PGW for the first distributed EPC. At a transition step 430, when the UE moves beyond the first distributed EPC to a second distributed EPC, the original connection resources for the user session are released. The original IP resources are held. The first distributed EPC notifies an HSS at a central EPC of the held IP resources and of the released connection resources. At a second connecting step 440, a tunnel is established between the first PGW and a second PGW for the second distributed EPC. The tunnel uses the original IP resources, retrieved from the HSS. The new connection uses new connection resources coordinated through the second distributed EPC. The tunnel is established by a coordination between a first MME at the first distributed EPC and a second MME at the second distributed EPC. At a routing step 450, user data is then routed from the UE, to the second PGW, through the tunnel to the first PGW, and to the network. The method then ends at an end step 460.

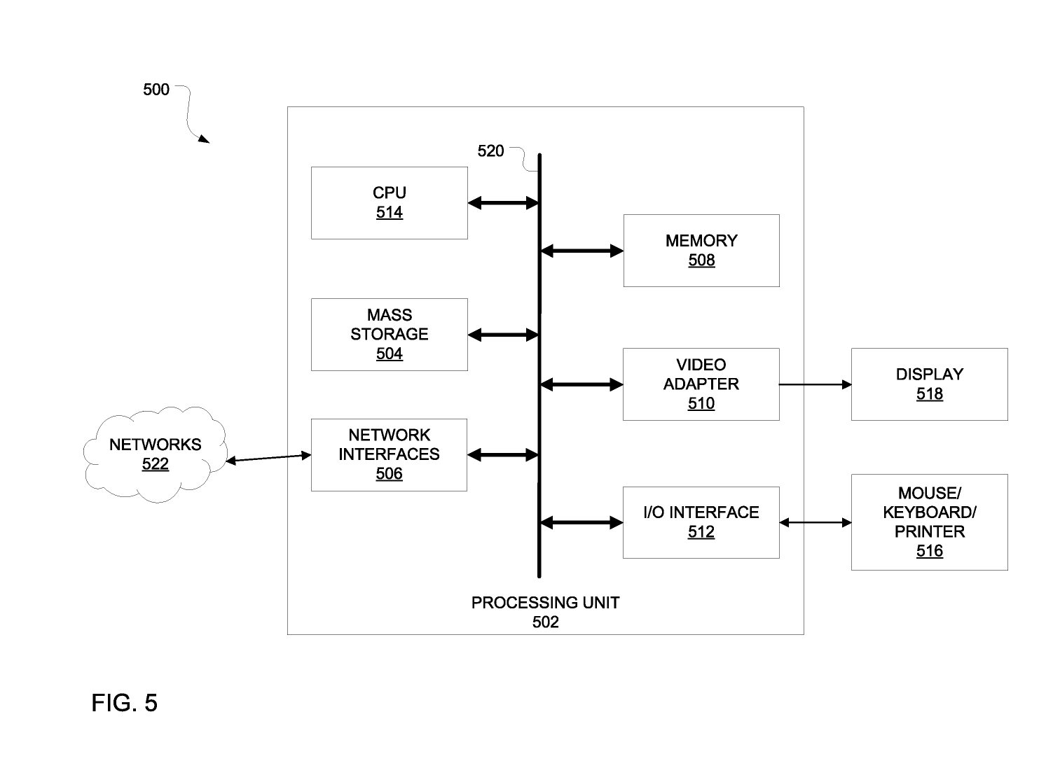

FIG. 5 is a block diagram of a processing system 500 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system 500 may comprise a processing unit 502 equipped with one or more input/output devices, such as a speaker, microphone, mouse, touchscreen, keypad, keyboard, printer, display, and the like. The processing unit may include a central processing unit (CPU) 514, memory 508, a mass storage device 504, a video adapter 510, and an I/O interface 512 connected to a bus 520.

The bus 520 may be one or more of any type of several bus architectures including a memory bus or memory controller, a peripheral bus, video bus, or the like. The CPU 514 may comprise any type of electronic data processor. The memory 508 may comprise any type of system memory such as static random access memory (SRAM), dynamic random access memory (DRAM), synchronous DRAM (SDRAM), read-only memory (ROM), a combination thereof, or the like. In an embodiment, the memory 508 may include ROM for use at boot-up, and DRAM for program and data storage for use while executing programs.

The mass storage 504 may comprise any type of storage device configured to store data, programs, and other information and to make the data, programs, and other information accessible via the bus 520. The mass storage 504 may comprise, for example, one or more of a solid state drive, hard disk drive, a magnetic disk drive, an optical disk drive, or the like.

The video adapter 510 and the I/O interface 512 provide interfaces to couple external input and output devices to the processing unit 502. As illustrated, examples of input and output devices include a display 518 coupled to the video adapter 510 and a mouse/keyboard/printer 516 coupled to the I/O interface 512. Other devices may be coupled to the processing unit 502 and additional or fewer interface cards may be utilized. For example, a serial interface such as Universal Serial Bus (USB) (not shown) may be used to provide an interface for a printer.

The processing unit 502 also includes one or more network interfaces 506, which may comprise wired links, such as an Ethernet cable or the like, and/or wireless links to access nodes or different networks. The network interfaces 506 allow the processing unit 502 to communicate with remote units via the networks. For example, the network interfaces 506 may provide wireless communication via one or more transmitters/transmit antennas and one or more receivers/receive antennas. In an embodiment, the processing unit 502 is coupled to a local-area network 522 or a wide-area network for data processing and communications with remote devices, such as other processing units, the Internet, remote storage facilities, or the like.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method of managing a user session and an internet protocol (IP) session for a connection between an user equipment (UE) and a network, comprising:
establishing, at a first distributed evolved packet core (EPC), the user session and the IP session over the connection through the first distributed EPC, wherein the first distributed EPC comprises a first packet data network (PDN) gateway (PGW) at which the IP session is anchored;
holding original IP resources for the IP session and releasing original connection resources for the user session at the first distributed EPC when the UE moves beyond the first distributed EPC to a second distributed EPC;
establishing a tunnel between the first PGW and a second PGW for the second distributed EPC, wherein the tunnel utilizes the original IP resources and new connection resources at the second distributed EPC; and
routing data for the user session and the IP session from the tunnel, through the first PGW, and to the network.

2. The method of claim 1 wherein the holding the original IP resources and the releasing the original connection resources further comprise informing a home subscriber server (HSS) at a centralized EPC.

3. The method of claim 2 wherein the establishing the tunnel includes re-authenticating the UE with the HSS according to the original IP resources.

4. The method of claim 3 wherein the establishing the tunnel includes obtaining values of the original IP resources from the HSS.

5. The method of claim 2 wherein the establishing the tunnel includes coordinating, by a first mobility management entity (MME) at the first distributed EPC, with a second MME at the second distributed EPC according to the original IP resources.

6. The method of claim 5 wherein the coordinating between the first MME and the second MME is carried out through information stored in the HSS.

7. The method of claim 1 further comprising receiving a request, at a second mobility management entity (MME) at the second distributed EPC, from the UE to release the original connection resources and to maintain the original IP resources and the IP session.

8. The method of claim 7 further comprising forwarding the request to release the original connection resources to a first MME at the first distributed EPC.

9. The method of claim 1 further comprising establishing another IP session for another connection via the second PGW to the network after the UE moves to the second distributed EPC.

10. The method of claim 1 wherein the establishing the user session and the IP session, the holding and releasing, the establishing the tunnel, and the routing are carried out by virtual functions implemented on at least one processing system.

11. A distributed evolved packet core (EPC), comprising:
a user plane couplable between a network and a radio node serving a user equipment (UE), wherein the user plane comprises:
a packet data network gateway (PGW) configured to anchor an internet protocol (IP) session for the UE, and
a serving gateway (SGW) configured to anchor a user session for the UE; and
a control plane comprising a mobility management entity (MME) configured to coordinate a first connection for the IP session and the user session and, when the UE transitions to being served by another radio node coupled to another distributed EPC, to:
instruct the PGW to release connection resources and hold IP resources for the first connection,
inform a centralized EPC of the release and the hold, and
coordinate a second connection for the IP session and the user session through a tunnel between the PGW and another PGW for the another distributed EPC according to an authorization from the centralized EPC.

12. The distributed EPC of claim 11 wherein the radio node comprises an enhanced node B (eNB).

13. The distributed EPC of claim 11 wherein the SGW is further configured to anchor the user session for UE mobility among a plurality of radio nodes couplable to the SGW.

14. The distributed EPC of claim 11 wherein the control plane is couplable to a home subscriber server (HSS) at the centralized EPC.

15. The distributed EPC of claim 14 wherein the MME is further configured to authenticate the UE with the HSS for the first connection.

16. The distributed EPC of claim 11 wherein the MME is further configured to receive a request from another MME for the another distributed EPC to release the connection resources and to maintain the IP session for the first connection, wherein the request originates at the UE and passes from the UE to the another radio node, to the another MME.

17. The distributed EPC of claim 11 wherein the control plane further comprises a policy and charging rules function (PCRF) coupled to the PGW and configured to administer subscriber policies for the UE through PGW.

18. The distributed EPC of claim 11 wherein the PGW, the SGW, and the MME are implemented as virtual functions on at least one processing system.

19. An evolved packet core (EPC) for serving a user equipment (UE), comprising:
a central EPC having a home subscriber server (HSS) configured to store authentication information and to authenticate and identify the UE;
a first distributed EPC having:
a first serving gateway (SGW) couplable to a first radio node and configured to anchor a user session for the UE and to route user data to and from the UE through the first radio node,
a first packet data network gateway (PGW) couplable between the first SGW and a network and configured to anchor an internet protocol (IP) session for the UE and to route the user data between the first SGW and the network, and
a first mobility management entity (MME) configured to receive an authentication of the UE from the HSS and coordinate establishment of the user session and the IP session; and
a second distributed EPC having:
a second SGW couplable to a second radio node and configured to route the user data to and from the second radio node,
a second PGW couplable between the second SGW and the network and configured to route the user data between the second SGW and the network, and
a second MME;
wherein, when the UE transitions from being served by the first radio node to being served by the second radio node, the first MME is configured to:
instruct the first PGW to release connection resources for the user session and to hold IP resources for the IP session, and
inform the HSS of the release of the connection resources and of the hold of the IP resources; and
wherein, when the UE initiates connectivity with the second radio node, the second MME is configured to:
receive a re-authentication of the UE from the HSS, and
coordinate with the HSS and the first MME to establish a tunnel between the first PGW and the second PGW according to the IP resources and through which the user data can be routed from the UE to the second PGW, to the first PGW, and to the network.

20. The EPC of claim 19 wherein the second MME is further configured to establish new IP sessions for the UE with the second PGW routed directly to the network.

21. The EPC of claim 19 wherein the central EPC further comprises a subscriber provisioning repository configured to store subscriber information for the UE.

22. The EPC of claim 19 wherein the first distributed EPC further comprises a policy and charging rules function coupled to the first MME and the first PGW and configured to provide dynamic quality of service (QoS) policies for the first PGW.

23. The EPC of claim 19 wherein the second MME is further configured to receive an address for the first PGW when the UE initiates connectivity with the second radio node.

24. The EPC of claim 19 wherein the second MME is further configured to:
receive a request from the UE to release the connection resources; and
forward the request to the first MME.

25. The EPC of claim 19 wherein the first distributed EPC further comprises a server on which the first MME is implemented as a virtual function.

26. The EPC of claim 19 wherein the HSS is further configured to store the IP resources for the UE in a location database.

27. The EPC of claim 19 wherein the first SGW, the first PGW, and the first MME are implemented as virtual functions on at least one processing system.
